(19) United States
(12) Patent Application Publication
(10) Pub. No.: US 2002/0182112 A1
(43) Pub. Date: Dec. 5, 2002

(54) In vivo method for measuring binding of chemical actives to skin or specific constituents of skin

(75) Inventors: Daniel Thorn Leeson, Hoboken, NJ (US); Krishna Kumar Subramanyan, Edgewater, NJ (US); Kavssery Parameswaran Ananthapadmanabhan, Highland Mills, NY (US)

Correspondence Address: UNILEVER, PATENT DEPARTMENT, 45 RIVER ROAD, EDGEWATER, NJ, 07020, US

(73) Assignee: Unilever Home & Personal Care USA, Division of Conopco, Inc.

(21) Appl. No.: 10/125,033

(22) Filed: Apr. 18, 2002

Related U.S. Application Data
(60) Provisional application No. 60/287,889, filed on Apr. 30, 2001.

(51) Int. Cl. G01N 21/64

(52) U.S. Cl. 422/82.08

(57) ABSTRACT

The present invention relates to an in vivo method for measuring the binding of chemical compounds or mixtures of compounds to skin constituents.

### RELATED APPLICATIONS

This application is a completion of Provisional Application, U.S. Serial No. 60/287,889, filed Apr. 17, 2001.

### FIELD OF THE INVENTION

The present invention relates to in vivo methods for measuring the binding of chemical actives, more specifically surfactants, to skin, and more specifically to proteins in skin.

### BACKGROUND OF THE INVENTION

In vivo and ex vivo methods for measuring the binding of chemicals, mainly surfactants, to skin are known. These methods typically involve applying a strongly absorbing or luminescent probe/marker either before or after treatment with a solution of the chemical compound or mixture of compounds in question, and subsequently measuring the intensity of the absorbance or luminescence on skin.

In “Cumulative effect of surfactants on cutaneous horny layers: Adsorption onto human keratin layers in vivo”, G. Imokawa and Y. Mishima, Contact Dermatitis 357:5 (1979), it is suggested that the absorbance of the probe/marker applied after treatment is a measure for the amount of binding by surfactants. It is argued that when surfactants bind to the skin during treatment they block potential binding sites for the probe/marker. Hence fewer probe probe/marker molecules bind to the skin resulting in a less intense color than is observed when the probe/marker is applied without treatment. However, the authors are not specific as to what the specific binding sites are, i.e. what constituents of skin the probe/marker binds to.

In “Interactions of cleansing bars with stratum corneum proteins: An in vitro fluorescence spectroscopic study, S. Mukherjee et al., J. Soc. Cosmet. Chem. 301:46 (1995), a protein-binding fluorescent probe/marker is applied to human and porcine skin ex vivo before treatment with various surfactant solutions. Subsequently, the fluorescence spectrum of the probe/marker is taken and the fractional displacement of the probe/marker by the surfactants is calculated by taking the ratio of the fluorescence intensity of the probe/marker to that of the tryptophan residues of the skin proteins. However, no changes in the spectral shape of the fluorescence spectrum of the probe/marker itself are observed. The method of the invention is not disclosed.

In “Pyranine, a fluorescent dye, detects subclinical injury to sodium lauryl sulfate”, A. Pagnoni et al., J. Cosmet. Sci. 33:49 (1998) a fluorescent probe/marker, 8-hydroxyl-1 ,3,6-pyrene-trisulfonic acid (pyranine) is applied in vivo after treatment. It is observed that when skin is exposed to sodium lauryl sulfate (SLS), an anionic surfactant, for 24 hours, a much stronger fluorescence is observed than when the probe is applied without any prior treatment. According to the argumentation used in the previously mentioned work, binding of SLS to the skin should lead to a decrease in the fluorescence. The fact that the fluorescence increases rather than decreases suggests that the 24-hour treatment reduces the barrier function of the skin, thus exposing more binding sites for the fluorescent probe/marker. This is supported by transepidermal water loss measurements.

### BRIEF DESCRIPTION OF THE INVENTION

The present invention relates to an in vivo method, for measuring the binding of chemical compounds, specifically surfactants, and more specifically surfactants from cleansers, to skin, and more specifically to proteins in skin.

The present invention discloses one specific embodiment for an in vivo measurement.

In the embodiment of the present invention, the amount of surfactant binding to the skin after application of a cleansing product is measured by choosing a desired spot on the subject's body; washing the skin with the product in question; applying a desired amount of a fluorescent probe/marker (e.g. pyranine) and obtaining a fluorescence spectrum of the area the fluorescent or absorbing probe was applied to, e.g. by using a fiber optic probe/marker; and calculating the ratio of the fluorescence intensity or absorbance of the probe/marker on skin at two different wavelengths.

More specifically, the invention comprises an in vivo method for measuring the binding affinity of chemicals, more specifically surfactants, either pure surfactants or surfactants from cleanser formulations, to skin, and more specifically to proteins in skin.

The method comprises:

1. choosing a desired site, typically 2×4″ but the site can be either smaller or larger, on the body of a subject;

2. exposing the body site to the chemical or formulation of interest. Exposure to the chemical can be done in any desired way. In the case of surfactants or cleanser formulations, exposure typically involves washing the skin with the surfactant or cleanser formulation;

3. applying the probe/marker to an area within the site that was exposed to the chemical formulation, typically a circular area of 0.5″ diameter, but the area can be any shape or size provided it fully overlaps with the site that was treated in step 2;

4. acquiring a luminescence or absorbance spectrum of the area of the skin that the probe/marker was applied to;

5. determining the binding affinity of the chemical compound to a specific constituent of skin, e.g. skin protein, e.g., by calculating the ratio of the fluorescence intensity or absorbance at two different wavelengths, or by measuring any change in the spectrum of the probe/marker other than its amplitude.

### BRIEF DESCRIPTION OF THE FIGURES

FIG. 1 depicts the fluorescence spectra of pyranine in 50 mM Hepes buffer containing 2.5 mg/ml BSA (dashed line); on human skin when applied topically (dotted line).

FIG. 2 depicts the fluorescence spectra of pyranine in 50 mM Hepes buffer (solid line); in 50 mM Hepes buffer containing 2.5 mg/ml BSA (dashed line); and in 50 mM Hepes buffer containing 2.5 mg/ml BSA and 4×10⁻⁵ weight fraction SDS (dotted line).

FIG. 3 depicts fluorescence spectra of pyranine when topically applied to skin without any prior treatment (solid line) and when applied after a two-minute wash with a harsh soap bar (dashed line).

FIG. 4 depicts the fluorescence spectra of pyranine when topically applied to skin after washing with a mild syndet bar (solid line) and after washing with a harsh soap bar (dashed line).

FIG. 5 depicts the results of a pilot clinical study. Displayed is the difference between the baseline fluorescence spectrum (no treatment) and the spectrum after a soap wash, as quantified by the difference in the ratio of the maximum fluorescence intensity and the intensity at 460 nm. Each bar represents the number of subjects.

### DETAILED DESCRIPTION OF THE INVENTION

The present invention relates to an in vivo method for measuring the ability of chemicals, more specifically surfactants, and even more specifically, surfactants applied from cleanser formulations, to bind to specific constituents of skin, e.g. proteins or lipids. The method is also applicable ex vivo. The method can be used as a quick and easy assay to determine the mildness of cleanser formulations.

Specifically, the invention provides a method for measuring the ability of chemicals to bind to proteins in skin in vivo comprising:

1. choosing a desired site, typically 2×2″, on the body of a subject;

2. exposing said site to the chemical compound in question, in the case of surfactants or cleanser formulations typically by washing the site, for any desired amount of time;

3. applying the luminescent or absorbing probe/marker, e.g., pyranine or any other probe/marker that exhibits a different luminescence or absorbance spectrum depending on its microenvironment within the skin, dissolved, typically in ethanol or water to typically a circular area approximately 0.5″ in diameter;

4. acquiring a luminescence or absorbance spectrum of the area of the skin that the probe/marker was applied to, e.g. by using a fiber optic probe/marker;

5. determining the binding affinity of the chemical compound to a specific constituent of skin, e.g. skin protein, by calculating the ratio of the fluorescence intensity or absorbance at two different wavelengths or by measuring any change in the spectrum of the probe/marker other than its amplitude.

Each of the process steps is discussed in more detail below and in the examples.

As noted, the first step in the in vivo method of determining the binding affinity of chemical compounds to specific constituents of skin according to the subject invention is to choose a desired spot on the subject suitable for measurements.

The method is applicable to any body site that can be treated with the chemical compound, the binding of which is to be measured. Restrictions in the size of the site to be chosen are only determined by the method of exposure to the chemical compound. For example, if the compound in question is a surfactant and it is applied through washing the body site with the surfactant, it would not be practical to choose an area smaller than roughly 0.5×0.5″ in size. However, if the method of exposure allows it, a body site of much smaller dimensions can be chosen. There is no upper limit on the size of the body site to be chosen. For example, if one desires to measure the binding of a cleanser formulation to skin, the whole body of the subject can be washed, and subsequently the binding can be measured at different sites on the body (see the second step).

In the second step of the invention, the body site that was chosen in the first step, is exposed to the chemical compound or mixture of compounds, the binding of which is to be measured.

There are no restrictions in the method by which the chemical compound is exposed to the skin or the duration of exposure other that it can be reasonably applied in vivo. If the method is applied ex vivo, there are no restrictions in the method or duration of exposure. Typical methods of exposure can be soaking the skin with the compound or mixture of compounds of interest, rubbing the skin with the compound, and particularly in the case of surfactants or cleanser formulations, washing the skin.

In the third step of the invention the luminescent or optically absorbing probe/marker is applied to the area that was exposed to the chemical compound(s) in the second step.

The probe/marker that is applied can be any probe/marker that exhibits differences in its luminescence or absorbance spectrum, other than the amplitude, depending on its microenvironment within the skin. Pyranine is a fluorescent probe/marker that can fluoresce both from a protonated and a deprotonated state. Each state fluoresces at different wavelengths. The fluorescence from the protonated state peaks between 430 nm and 460 nm, while the fluorescence from the deprotonated state peaks at 510 nm. The ratio of the fluorescence intensities from the two different states is strongly dependent on the micro-environment of the molecule. For instance, the fluorescence spectrum of pyranine dramatically changes when it is bound to proteins as is illustrated in Example 1. This makes pyranine a preferred probe/marker to measure the binding of chemical compounds to skin proteins as is illustrated in Example 3. Different probes/markers may be used to measure binding of chemicals to constituents of skin other than proteins. For example, a probe/marker that exhibits a change in its luminescence or absorbance spectrum when it is in a lipid environment, would be a candidate to measure the binding of chemicals to skin lipids. In vitro luminescence or absorption spectra may be taken to determine the preferred micro-environment of a probe/marker (see Example 2).

There are no restrictions in the method by which the probe/marker is applied to the skin, or the duration of application other that it can be reasonably applied in vivo. If the method is applied ex vivo, the are no restrictions in the method or duration of exposure. Typical would be to topically apply the probe from solution, e.g. dissolved in alcohol or water, to a circular area of approximately 0.5″ in diameter. There are no restrictions to the size of the area that the probe/marker is applied to other than that it should fall within the area that was exposed to the chemical compounds in the second step. In some cases it may be desirable to expose a relatively large area in the second step, for instance by washing the whole forearm, and then subsequently apply the probe/marker to several smaller areas within the larger area that was exposed to the chemical compound.

In the fourth step of the invention a luminescence or absorbance spectrum is obtained of the probe/marker on skin. Typically these spectra are taken with a fluorometer (for fluorescent probe/markers) or a spectrophotometer (for absorbing probe/markers). It is important that the area of the skin that is covered by the measurement is equal to or smaller than the area of the skin that the probe/marker was applied to in the third step. This can be typically achieved by using a fiber optic probe/marker to illuminate the skin with the excitation light and to collect the resulting fluorescence light (for fluorescent probe/marker) or by applying the incident light and collecting the reflected light (for absorbing probe/marker).

In the fifth step of the invention the spectrum that is measured in the fourth step is analyzed to determine the binding of the chemical compound or mixture of compounds that was applied in the second step. For example, this can be done by taking the ratio of the fluorescence intensity or absorbance at two different wavelengths in the spectrum or by determining the wavelength of maximum fluorescence intensity or absorbance.

Except in the operating and comparative examples, or where otherwise explicitly indicated, all numbers in this description indicating amounts or ratios of materials or conditions or reaction, physical properties of materials and/or use are to be understood as modified by the word “about”.

Where used in the specification, the term “comprising” is intended to include the presence of stated features, integers, steps, components, but not to preclude the presence or addition of one or more features, integers, steps, components or groups thereof.

The following examples are intended to further illustrate the invention and are not intended to limit the invention in any way.

Unless indicated otherwise, all percentages are intended to be percentages by weight.

Methodology

Equipment

Fluorescence spectra of pyranine in solutions and on skin were obtained using a Perkin Elmer LS50B fluorometer. In the case of spectra taken on skin, the fiber optic probe accessory was used.

Experimental Procedure

In Vitro Experiments:

All spectra were taken at pyranine concentrations of 1.0×10⁻⁸ M in 50 mM Hepes buffer (aqueous buffer solution with pH 6.7). Bovine Serum Albumim (BSA) concentrations were 2.5 mg/ml. Surfactant was added at weight fractions of 4×10⁻⁵.

In Vivo Experiments:

An area on the volar forearm, approximately 4×2″ in size, was washed with either a Dove® or an Ivory® soap bar for 2 minutes. The skin was subsequently rinsed with tap water for 10 seconds and subsequently patted dry. 100 μl of a 10,000 ppm solution of pyranine in ethanol was applied to a circular area of 0.5″ diameter at the center of the area that was washed. The fiber optic probe/marker was placed at the center of the circular area and the fluorescence spectrum was obtained

### EXAMPLE 1

Dependence of the Pyranine Fluorescence Spectrum on Micro-Environment

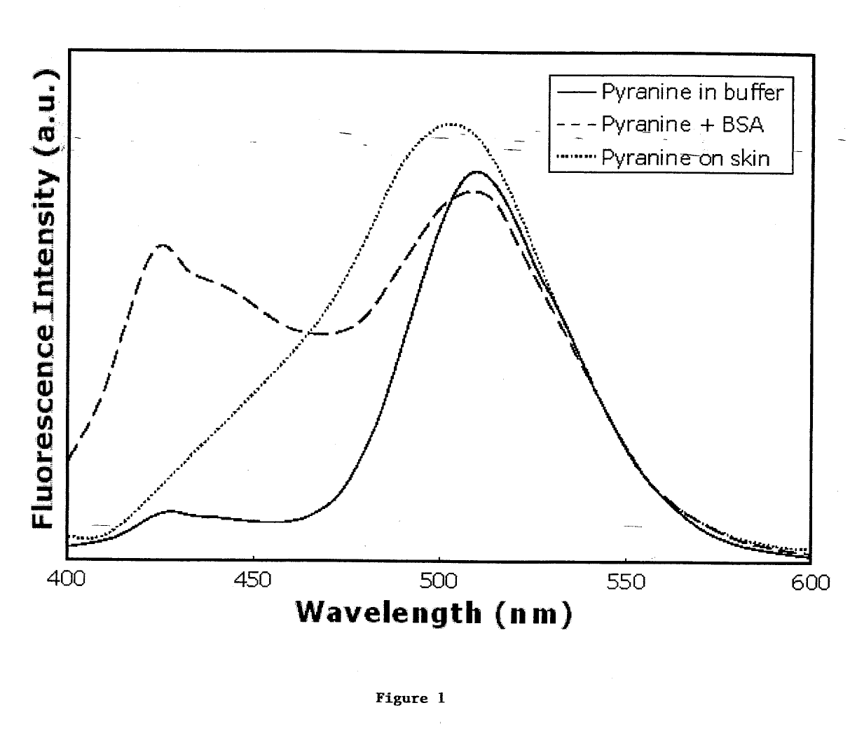

FIG. 1 displays fluorescence spectra of pyranine in three different environments; dissolved in an aqueous buffer, dissolved in the same buffer with added protein (BSA), and on human skin, in vivo.

The spectrum in aqueous buffer shows an intense band, centered at around 510 nm. This band corresponds to the deprotonated state as was discussed earlier. In addition, a minor band around 425 nm can be observed, arising from the protonated state. When BSA is added the same bands can be observed in the spectrum, but with largely different relative intensities. The change in the relative intensities of the two bands results from binding of pyranine to the protein. In this different micro-environment, fluorescence from the deprotonated form of pyranine is less favored than in free solution. The fluorescence spectrum of pyranine on skin also clearly exhibits multiple bands. The fluorescence from the protonated state is red-shifted relative to the free solution spectrum and clearly more intense. The fluorescence from the deprotonated state does not seem to have shifted significantly relative to the free solution spectrum. The higher relative intensity of the fluorescence from the protonated state suggests that topically applied pyranine binds to skin proteins.

### EXAMPLE 2

The Effect of Surfactants on the Spectrum of Pyranine in Protein Solution

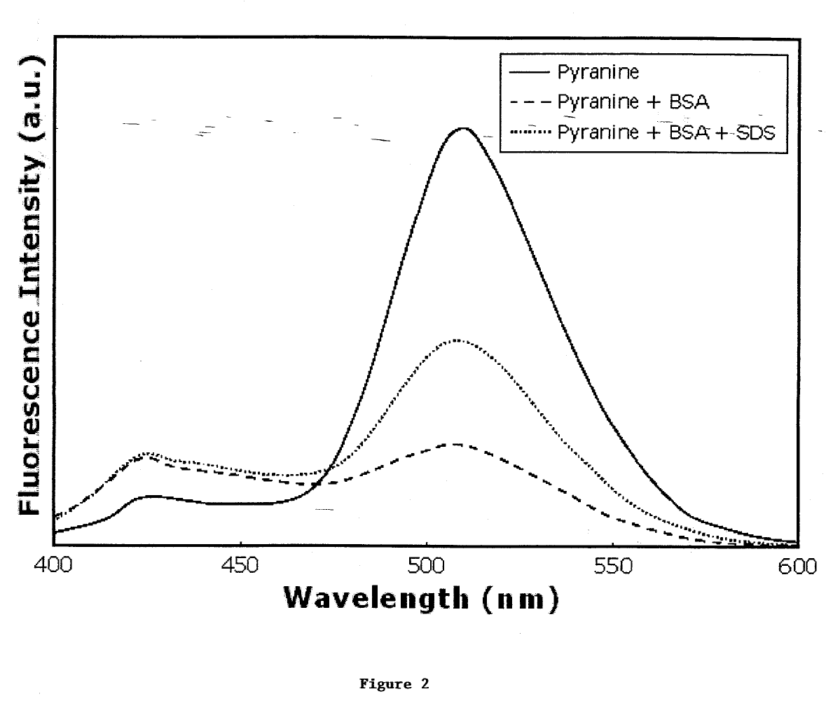

In order to test the applicability of pyranine fluorescence to monitor the binding of surfactants to proteins, applicants studied the effect of added surfactant on the fluorescence spectrum of aqueous solutions of pyranine and BSA. FIG. 2 shows how the addition of sodium dodecyl sulphate (SDS) results in a significant increase of the relative intensity of the fluorescence from the deprotonated state. This effect can be explained by the replacement of pyranine molecules bound to BSA by SDS molecules leading to an increased concentration of pyranine in free solution and therefore a relative increase in intensity of the fluorescence from the deprotonated state. The ratio of the fluorescence intensities from the deprotonated and protonated site is a measure of the ability of a surfactant to replace pyranine from BSA binding sites. Table 1 below shows this ratio for a number of surfactants when added to a pyranine/BSA solution at equal weight fractions. It is clear from Table 1 that surfactants that are well known to be harsh to skin, such as SDS, have a higher ratio than known milder surfactants such as alkylpolyglycoside (APG) suggesting that the harshness/mildness of surfactants is, at least in part, determined by their affinity for protein binding sites.

TABLE 1

| System | \|509 nm\|426 nm |
|---|---|
| Pyranine | 8.03 |
| Pyranine + BSA + SDS | 2.23 |
| Pyranine + BSA + Sodium Laurate | 2.13 |
| Pyranine + BSA + Sodiumlauryl Ether Sulfate | 2.12 |
| Pyranine + BSA + Cocamilopropyl Betaine | 1.56 |
| Pyranine + BSA + APG | 1.34 |
| Pyranine + BSA | 1.17 |

### EXAMPLE 3

The Effect of a Soap Wash on the Fluorescence Spectrum of Pyranine on Skin

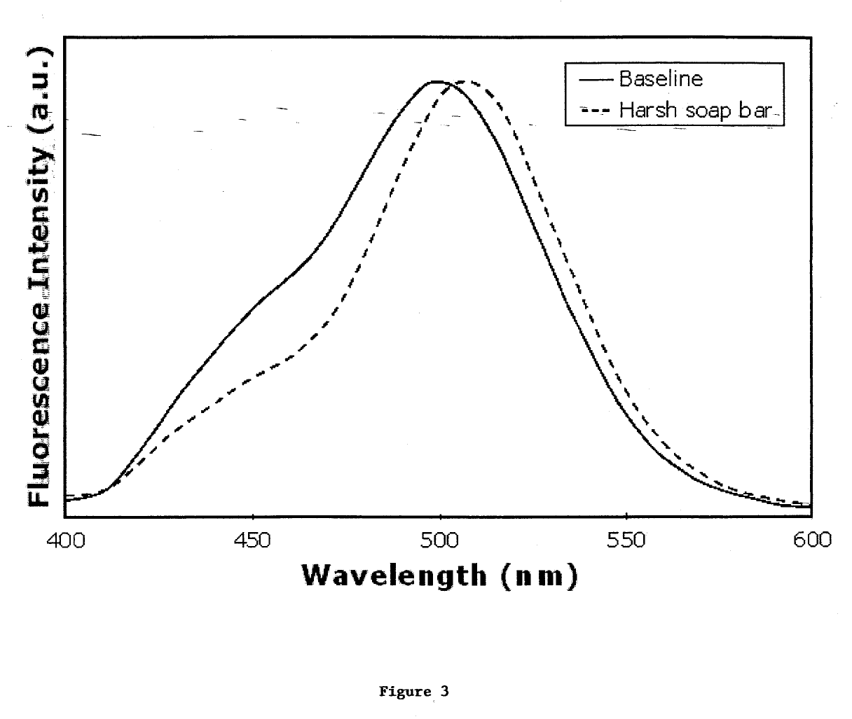

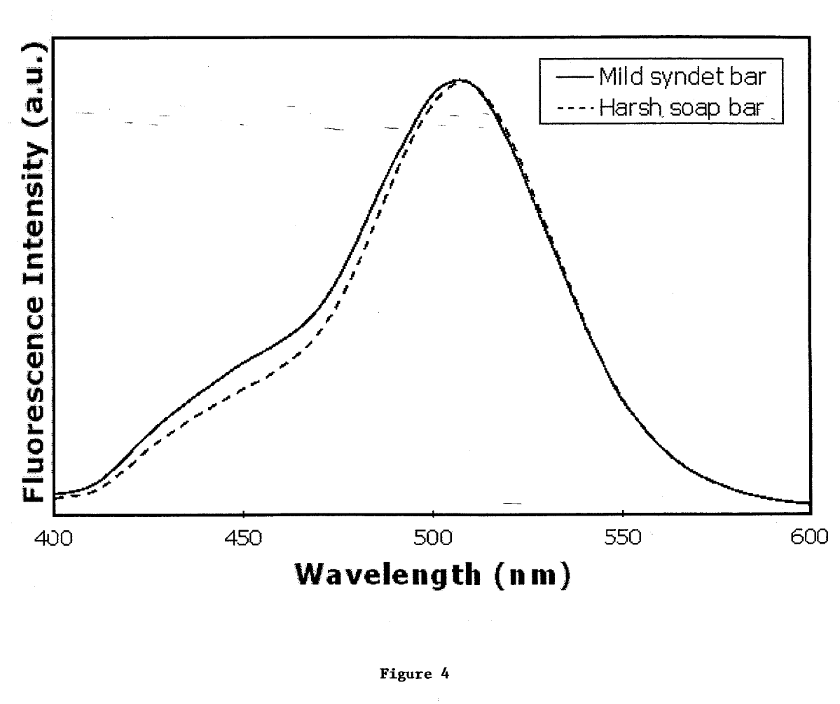

FIG. 3 shows two fluorescence spectra of pyranine on skin, one where pyranine was applied without any prior treatment and one where pyranine was applied after a two-minute arm wash with a harsh soap bar. The soap treatment leads to a significant change in the fluorescence spectrum, most notably a reduced intensity of the band around 450 nm. The reduced intensity of the fluorescence from the protonated state is most likely due to the binding of surfactants from the soap bar to protein binding sites on skin. When pyranine is applied after the soap wash some potential binding sites will already be occupied by surfactant molecules and therefore part of the probe molecules will bind superficially leading to a reduction of the fluorescence from the protonated state. This effect is significantly reduced when using a mild sylidet bar as is shown in FIG. 4, which shows spectra both after washing with a harsh soap bar and a mild syndet bar.

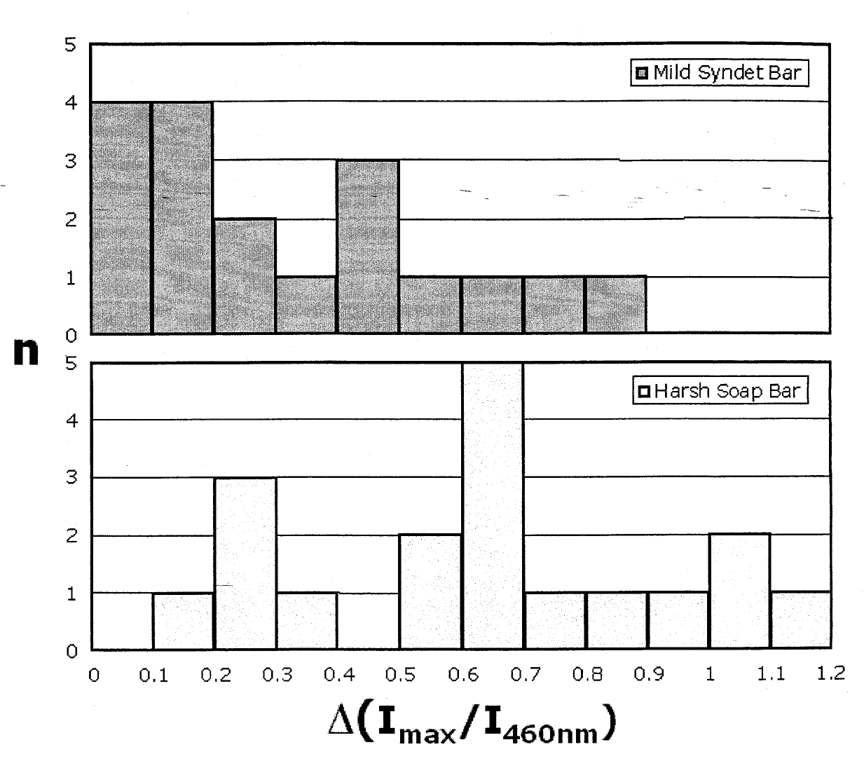

The effect of a soap wash on the fluorescence spectrum of pyranine on skin can be quantified by taking the ratio of the fluorescence intensity at peak height and the intensity at 460 nm, and subsequently taking the difference between this ratio before and after washing with the soap bar. FIG. 5 displays the results of a pilot clinical study clearly showing an overall stronger effect for the harsh soap bar.

1. An in vivo method for measuring the binding of chemical compounds or mixtures of compounds to skin constituents comprising:
(a) choosing a desired site of any desired size on a subject's body;
(b) exposing said site, the binding of which is to be measured, to the chemical compound or mixture of compounds by any desirable method;
(c) applying a luminescent or optically absorbing probe/marker to the area that was exposed to the chemical compound or compounds;
(d) measuring the luminescence or absorbance spectrum of the probe/marker on skin; and
(e) determining the binding of the chemical compound or compounds the body site was exposed to from the luminescence or absorbance spectrum.

2. A method according to claim 1, wherein chemical compound measured is a surfactant or surfactants.

3. A method according to claim 1, wherein skin constituent measured is a skin protein or proteins.

4. A method according to claim 1, wherein said binding of step (e) is determined by measuring fluorescence or absorbance at two different wavelengths and quantifying ratio of the two or by measuring any change in the probe/marker other than its amplitude.

5. A method to determine mildness of a cleanser formulation which method comprises:
(a) choosing a desired skin site of desired size on a subject's body;
(b) washing said skin with a surfactant or cleanser composition;
(c) applying luminescent or optically absorbing probe/marker to the area exposed to surfactant or cleansing composition;
(d) measuring the luminescence or absorbance spectrum of the probe/marker on skin; and
(e) determining the binding of surfactant or cleanser composition to body site exposed to from the luminescence absorbance.
